(19) United States
(12) Patent Application Publication
(10) Pub. No.: US 2013/0273233 A1
(43) Pub. Date: Oct. 17, 2013

(54) COMPOSITIONS AND METHODS FOR EVENLY DISTRIBUTING INCLUSIONS IN A NUT BUTTER BASE

(71) Applicant: KRAFT FOODS GLOBAL BRANDS LLC, Northfield, IL (US)

(72) Inventors: Anna Olsen, Chicago, IL (US); Maria Plata, Mount Prospect, IL (US); Vincent LeClerc, Montreal (CA); Trevor Sweeney, Evanston, IL (US); Judith Gulten Moca, Palatine, IL (US); Ed Parker, Kathleen, GA (US); Kim Chau, Ontario (CA)

(21) Appl. No.: 13/828,830

(22) Filed: Mar. 14, 2013

Related U.S. Application Data
(60) Provisional application No. 61/624,058, filed on Apr. 13, 2012.

(51) Int. Cl. A23L 1/38

(52) U.S. Cl. CPC A23L 1/38
USPC 426/633

(57) ABSTRACT

Disclosed are ground nut compositions containing one or more evenly distributed solid inclusions, and methods of manufacturing the same.

### CROSS-REFERENCE TO RELATED APPLICATIONS

This application claims priority benefit from U.S. Provisional Patent Application No. 61/624,058, filed on Apr. 13, 2012, which is incorporated by reference in its entirety.

### BACKGROUND

The present invention generally relates to food technology, and more particularly, to ground nut compositions containing one or more evenly distributed solid inclusions, and methods of manufacturing the same.

### BRIEF SUMMARY

Encompassed herein is a packaged nut composition comprising a base, the base comprising about 60 wt % to about 90 wt % ground nuts having a grind size of about six half mil as measured using a Hegman gauge and the method of ASTM D-1210, about 0 wt % to about 8 wt % sweetener, about 0 wt % to about 5 wt % salt, and about 0 wt % to about 3 wt % stabilizer, the base further comprising about 5 wt % to about 30 wt % inclusions having a density that is about the same as the density of the ground nuts, the inclusions being substantially evenly distributed in the packaged nut spread, and the packaged nut spread having substantially the same distribution of inclusions in a proximal third, a middle third, and a distal third of the nut spread as packaged.

In an embodiment, the base further comprises about 0 wt % to about 2 wt % spice, about 0 wt % to about 2 wt % flavoring, about 0 wt % to about 12 wt % soybean oil, and about 0 wt % to about 7 wt % corn dextrin. In an embodiment, the sweetener is powdered sugar and the ground nuts are roasted Runner peanuts.

In an embodiment, the base has a particle size distribution with a span of about 3 to about 4, such that at least 90% of the particles are smaller than about 50 microns, at least 50% of the particles are smaller than about 15 microns, and about 10% of the particles are smaller than about 2 microns.

In an embodiment, the inclusions have a particle size distribution of about 1% to about 5% of inclusions retained on a 9.5 mm sieve, about 10% to about 20% of inclusions retained on an 8.7 mm sieve, about 40% to about 50% of inclusions retained on a 6.7 mm sieve, and about 15% to about 25% of inclusions retained on a 4.75 mm sieve.

In an embodiment, the packaged nut spread has a Brookfield viscosity from about 6,000 to about 14,000 centipoise measured at a temperature of 85 degrees C. after 60 seconds at 20 rpm with a spindle D, heliopath.

In an embodiment, the packaged nut spread comprises crushable inclusions, wherein the crushable inclusions are substantially uncrushed. In an embodiment, all of the inclusions are readily crushable to particle sizes less than ¼ inch. In another embodiment, all of the inclusions are readily crushable to particle sizes less than ⅛ inch.

In an embodiment, the inclusions include granola. In an embodiment, the inclusions include glycerated fruit. In an embodiment, the inclusions include at least one confectionary selected from the group consisting of sugar coated chocolate and compound coating chocolate flavored pieces and combinations thereof. In an embodiment, at least one inclusion is selected from the group consisting of granola, fruit pieces, confectionary pieces, nut pieces and combinations thereof.

Encompassed herein is a method of producing a packaged nut spread having inclusions being substantially evenly distributed in the packaged nut spread, the method comprising forming a fluid base comprising about 60 wt % to about 90 wt % ground nuts having a grind size of six half mil as measured using a Hegman gauge and the method of ASTM D-1210, about 0 wt % to about 8 wt % sweetener, about 0 wt % to about 5 wt % salt, and about 0 wt % to about 3 wt % stabilizer, the method further comprising cooling the fluid base to about 96 degrees F. to about 105 degrees F., blending into the cooled fluid base inclusions having a density that is about the same as a density of the ground nuts, and packaging the nut spread with inclusions to form a packaged nut spread having inclusions that are substantially evenly distributed in the packaged nut spread, the packaged nut spread having substantially the same distribution of inclusions in the proximal third, middle third, and distal third of the nut spread as packaged.

In an embodiment, the method produces a base having a particle size distribution with a span of about 3 to about 4, such that at least 90% of the particles are smaller than about 50 microns, at least 50% of the particles are smaller than about 15 microns, and about 10% of the particles are smaller than about 2 microns. In an embodiment, the inclusions have a particle size distribution of about 1% to about 5% of inclusions retained on a 9.5 mm sieve, about 10% to about 20% of inclusions retained on an 8.7 mm sieve, about 40% to about 50% of inclusions retained on a 6.7 mm sieve, and about 15% to about 25% of inclusions retained on a 9.5 mm sieve.

In an embodiment, a method produces a packaged nut spread having a Brookfield viscosity from about 6,000 to about 14,000 centipoise measured at a temperature of 85 degrees C. after 60 seconds at 20 rpm with a spindle D, heliopath.

In an embodiment, the inclusions are added to the fluid base using a continuous flow mixer operating at a setting such that about at least 75% of the inclusions maintain the same particle size immediately after addition to the fluid base. In an embodiment, the continuous flow mixer is a screw-type mixer. In an embodiment, the continuous flow mixer is temperature-controlled. In an embodiment, the inclusions are added to the fluid base using a continuous flow mixer operating at a speed of about 15 RPM or less. In an embodiment, the inclusions are added to the fluid base using a continuous slurry mixer operating at a setting such that about at least 75% of the inclusions maintain the same particle size immediately after addition to the fluid base.

### BRIEF DESCRIPTION OF THE DRAWINGS

FIG. 1 is a process flow diagram illustrating an embodiment of a method encompassed herein for incorporating inclusions into a ground nut base.

FIG. 2 is an image depicting the particle size distribution for the ground peanut base composition encompassed herein, illustrating the measurement for total particles, including water soluble particles and water insoluble particles. The measurement was taken on three separate samples using a Horiba Laser Scattering Particle Size Distribution Analyzer, LA-900.

### DETAILED DESCRIPTION

One embodiment of the disclosure encompassed herein includes a composition including a base comprised of one or more types of ground nuts, and at least one type of inclusion, the inclusion having a median particle size larger than the median particle size of the ground nut base. The inclusions are substantially evenly distributed within the composition. In an aspect of one embodiment, the composition is packaged. In an embodiment, a composition is a packaged composition that includes a base comprised of one or more types of ground nuts, and at least one type of inclusion, the inclusion having a median particle size larger than the median particle size of the ground nut base, the inclusions being substantially evenly distributed within the packaged composition. In an embodiment, the packaged composition has substantially the same physical distribution of inclusions in a proximal third, a middle third, and a distal third of the composition as packaged.

As the term is used herein, “nut” is intended encompass the culinary definition of nuts, rather than strictly the botanical definition of nuts. Therefore, as used herein, the term “nut’ encompasses legumes, such as peanuts, and various dried seeds and fruits, such as walnuts, as well as nuts of the traditional botanical definition, such as hazelnuts.

Compositions

Compositions encompassed herein include ground nut compositions such as, but not limited to, nut butters, nut spreads, and nut pastes. In an embodiment, any nut may be used for a composition encompassed herein, including, but not limited to, peanuts, almonds, hazelnuts, macadamia nuts, cashews, pecans, pistachios, and walnuts. In an embodiment, two or more types of nuts may be used in a composition encompassed herein (e.g., peanuts and almonds). In an embodiment, two or more varieties of the same type of nut may be used in a composition encompassed herein (e.g., various peanut cultivars, such as runner peanuts and Spanish peanuts). In an embodiment, a composition encompassed herein includes two or more types of nuts and two or more varieties of at least one of the types of nuts. In an embodiment, a ground nut base comprises runner peanuts. In an embodiment, the ground nuts in a ground nut base consist of runner peanuts.

In an embodiment, the packaged ground nut compositions disclosed herein comprise between about 50% and about 95% by weight ground peanuts. In an embodiment, the packaged ground nut compositions disclosed herein comprise between about 55% and about 90%, between about 60% and about 85%, between about 65% and about 80%, or between about 70% and about 75% by weight ground peanuts. In an embodiment, the weight percentage of peanuts is the difference between 100% and the total weight percentage of all other components, including any ingredients added to the ground nut base, any inclusions, and any ingredients added to the packaged ground nut composition. In an embodiment, the packaged ground nut compositions comprise at least about 50%, at least about 55%, at least about 60%, at least about 65%, at least about 70%, at least about 75%, at least about 80%, at least about 85%, at least about 90%, or at least about 95% ground peanuts by weight. In an embodiment, the packaged ground nut compositions comprise less than about 50%, less than about 55%, less than about 60%, less than about 65%, less than about 70%, less than about 75%, less than about 80%, less than about 85%, less than about 90%, or less than about 95% ground peanuts by weight. In an embodiment, the packaged ground nut compositions comprise about 50%, about 55%, about 60%, about 65%, about 70%, about 75%, about 80%, about 85%, about 90%, or about 95% ground peanuts by weight.

In an embodiment, the components of the composition are manipulated in order to obtain a desired ground nut base. In an embodiment, one or more stabilizers are added to a ground nut composition, either to the ground nut base, to the ground nut composition comprising the inclusions, or to both the base and the inclusion-containing composition. Stabilizers useful in ground nut compositions encompassed herein include, but are not limited to, fats, oils, and hydrogenated oils. In an embodiment, a stabilizer is a hydrogenated vegetable oil. In an embodiment, the vegetable oil is fully hydrogenated. In an embodiment, a vegetable oil is partially hydrogenated. In an embodiment, a hydrogenated vegetable oil includes one type of oil (e.g., rapeseed oil). In another embodiment, a hydrogenated vegetable oil includes two or more types of oil (e.g., rapeseed and cottonseed). In an embodiment, a stabilizer is a fully hydrogenated vegetable oil comprising rapeseed, cottonseed, and soybean oils. In an embodiment, a stabilizer is a fully hydrogenated vegetable oil consisting essentially of rapeseed, cottonseed, and soybean oils. In an embodiment, a stabilizer is a fully hydrogenated vegetable oil consisting of rapeseed, cottonseed, and soybean oils. In an embodiment, a stabilizer is a natural stabilizer. In an embodiment, a natural stabilizer is not modified after isolation from its natural source. In an embodiment, a natural stabilizer is not hydrogenated. In an embodiment, a natural stabilizer is palm oil. In an embodiment, a stabilizer is a monoglyceride. In another embodiment, a stabilizer is a diglyceride. In another embodiment, a composition comprises a single stabilizer. In another embodiment, a composition comprises at least two stabilizers.

In an embodiment, no stabilizer is added to a ground nut base. In an embodiment, a stabilizer is added to a ground nut base between 0% and about 5% by weight. In an embodiment, a stabilizer is added to a ground nut base between about 0.5% and about 4.5%, between about 1% and about 4%, between about 1.5% and about 3.5%, between about 1.5% and about 2.5%, between about 1.3% and about 2%, between about 1.5% and about 2%, and between about 2% and about 3%. In an embodiment, a stabilizer is added to a ground nut base to about 0.5% by weight, about 1%, about 1.3%, about 1.5%, about 1.8%, about 2%, about 2.5%, about 3%, about 3.5%, about 4%, about 4.5%, or about 5%. In an embodiment, a stabilizer is added to a ground nut base to greater than 5% by weight. In an embodiment, a stabilizer is added to a ground nut base to at least about 0.5% by weight, at least about 1%, at least about 1.5%, at least about 2%, at least about 2.5%, at least about 3%, at least about 3.5%, at least about 4%, at least about 4.5%, or at least about 5%. In an embodiment, a stabilizer is added to a ground nut base to less than about 0.5% by weight, less than about 1%, less than about 1.5%, less than about 2%, less than about 2.5%, less than about 3%, less than about 3.5%, less than about 4%, less than about 4.5%, or less than about 5%.

In an embodiment, one or more flavorants are added to a ground nut base. In another embodiment, no flavorants are added to a ground nut base. Flavorants include, but are not limited to, salt, salt substitutes, natural sweeteners (sucrose, non-nutritive sweeteners, etc. . . . ), artificial sweeteners (sucralose, aspartame, etc. . . . ), natural flavors, and artificial flavors. Flavorants may be added as solids or as liquids, or as a combination thereof. In an embodiment, a flavorant is added to a ground nut base at between 0% and about 15% by weight.

In an embodiment, a flavorant is salt. In an embodiment, salt is added to a ground nut base between 0% and about 5%, between about 0.5% and about 4.5%, between about 1% and about 4%, between about 1.5% and about 3.5%, between about 1.5% and about 2.5%, between about 1.5% and about 2%, and between about 2% and about 3%. In an embodiment, salt is added to a ground nut base to about 0.5% by weight, about 1%, about 1.5%, about 2%, about 2.5%, about 3%, about 3.5%, about 4%, about 4.5%, or about 5%. In an embodiment, salt is added to a ground nut base to greater than 5% by weight. In an embodiment, a salt is added to a ground nut base to at least about 0.5% by weight, at least about 1%, at least about 1.5%, at least about 2%, at least about 2.5%, at least about 3%, at least about 3.5%, at least about 4%, at least about 4.5%, or at least about 5%. In an embodiment, salt is added to a ground nut base to less than about 0.5% by weight, less than about 1%, less than about 1.5%, less than about 2%, less than about 2.5%, less than about 3%, less than about 3.5%, less than about 4%, less than about 4.5%, or less than about 5%.

In an embodiment, a flavorant is sugar. In an aspect of one embodiment, a sugar is powdered sugar. In an embodiment, sugar is added to a ground nut base between 0% and about 10%, between about 0.5% and about 9.5%, between about 1% and about 9%, between about 1.5% and about 8.5%, between about 2% and about 8%, between about 2.5% and about 7.5%, about 3% and about 7%, about 3.5% and about 6.5%, about 4% and about 6%, and between about 4.5% and about 5.5%. In an embodiment, sugar is added to a ground nut base to about 0.5% by weight, about 1%, about 1.5%, about 2%, about 2.5%, about 3%, about 3.5%, about 4%, about 4.5%, about 5%, about 5.5%, about 6%, about 6.5%, about 7%, about 7.5%, about 8%, about 8.5%, about 9%, about 9.5%, or about 10%. In an embodiment, sugar is added to a ground nut base to greater than 10% by weight. In an embodiment, sugar is added to a ground nut base to at least about 0.5% by weight, at least about 1%, at least about 1.5%, at least about 2%, at least about 2.5%, at least about 3%, at least about 3.5%, at least about 4%, at least about 4.5%, at least about 5%, at least about 5.5%, at least about 6%, at least about 6.5%, at least about 7%, at least about 7.5%, at least about 8%, at least about 8.5%, at least about 9%, at least about 9.5%, or at least about 10%. In an embodiment, sugar is added to a ground nut base to less than about 0.5% by weight, less than about 1%, less than about 1.5%, less than about 2%, less than about 2.5%, less than about 3%, less than about 3.5%, less than about 4%, less than about 4.5%, less than about 5%, less than about 5.5%, less than about 6%, less than about 6.5%, less than about 7%, less than about 7.5%, less than about 8%, less than about 8.5%, less than about 9%, less than about 9.5%, or less than about 10%.

In an embodiment, other flavorants include, but are not limited to, cinnamon, natural fruit flavors, and artificial fruit flavors. Flavorants may be added as powders, liquids, or a combination of the two.

In an embodiment, compositions encompassed herein may also optionally comprise one or more of an emulsifier, a bulking agent (e.g., corn dextrin, soybean oil), or any combination thereof.

The ground nut compositions encompassed herein comprise at least one inclusion in addition to the ground nut base. In an embodiment, ground nut composition comprises at least two different types of inclusions. Inclusions include, but are not limited to, fruits (e.g., dried, glycerated; whole or pieces), nuts (e.g., whole or pieces), chocolate pieces, confectionery (e.g., sugar coated chocolate), granola (e.g., clusters or loose), chocolate flavored pieces, seeds, marshmallow products (including marshmallows), cookies, cookie pieces, biscuits, and biscuit pieces.

In an embodiment, inclusions are added to a ground nut base in a range of about 2% to about 40% by weight of a packaged ground nut composition. It will be understood that the weight percent of inclusions refers to the total weight of inclusions, whether a single type of inclusion is added or whether two or more different types of inclusions are added. By way of a non-limiting example, an inclusion level of about 15% inclusions, when granola clusters and banana pieces are used, can refer to any weight combination of granola clusters and banana pieces that add up to about 15% of the ground nut composition by weight. In an embodiment, inclusions are added to a ground nut base in a range of about 3% to about 35%, about 5% to about 30%, about 10% to about 25%, or about 15% to about 20% by weight of a packaged ground nut composition. In an embodiment, the weight percentage of inclusions is the difference between 100% and the total weight percentage of all other components, including the ground nuts, any ingredients added to the ground nut base, and any non-inclusion ingredients added to the packaged ground nut composition (e.g., a flavorant). In an embodiment, inclusions are added to a ground nut base to about 2.5%, about 5%, about 7.5%, about 10%, about 12.5%, about 15%, about 20%, about 25%, about 30%, about 35%, or about 40% by weight of a packaged ground nut composition. In an embodiment, inclusions are added to a ground nut base to at least about 2.5%, at least about 5%, at least about 7.5%, at least about 10%, at least about 12.5%, at least about 15%, at least about 20%, at least about 25%, at least about 30%, at least about 35%, or at least about 40% by weight of a packaged ground nut composition. In an embodiment, inclusions are added to a ground nut base to less than about 2.5%, less than about 5%, less than about 7.5%, less than about 10%, less than about 12.5%, less than about 15%, less than about 20%, less than about 25%, less than about 30%, less than about 35%, or less than about 40% by weight of a packaged ground nut composition.

In an embodiment, an inclusion is crushable. In an embodiment, a ground nut composition comprises crushable inclusions. In an embodiment, a crushable inclusion is an inclusion that can be broken apart into at least two pieces smaller than the original inclusion. In an embodiment, a crushable inclusion is an inclusion that can be broken apart with mechanical force. In an embodiment, the mechanical force is provided by mastication. In an embodiment, an inclusion is friable. In an embodiment, an inclusion is chewy. In an embodiment, a crushable inclusion is an inclusion that resists being crushed when added to a ground nut base or a ground nut composition, but is readily crushable by mastication. In an embodiment, at least one crushable inclusion is distributed evenly throughout a packaged ground nut composition as encompassed herein, and resists being crushed in the ground nut composition, but is readily crushable by mastication. In an embodiment, a packaged ground nut composition has substantially the same physical distribution of crushable inclusions in a proximal third, a middle third, and a distal third of the composition as packaged, and resists being crushed in the ground nut composition, but is readily crushable by mastication. In an embodiment, at least about 75% of the crushable inclusions in a ground nut composition remain substantially uncrushed after addition to the ground nut composition. In an embodiment, at least about 75% of the crushable inclusions in a packaged ground nut composition remain substantially uncrushed while the ground nut composition is in the package. In an embodiment, substantially all of the crushable inclusions in a packaged ground nut composition remain substantially uncrushed while the ground nut composition is in the package. In an embodiment, crushable inclusions are referred to as being substantially uncrushed in a packaged ground nut composition if the integrity of the crushable inclusions is substantially the same in the ground nut composition as it was immediately prior to the addition of the inclusions to the ground nut composition.

In another embodiment, an inclusion is not crushable.

In an embodiment, the characteristics of the composition are manipulated in order to obtain a desired ground nut base. In another embodiment, the characteristics and components of the composition are manipulated in order to obtain a desired ground nut base. In an aspect of one embodiment, the manner of grinding the nuts can impart different properties to the ground nut base used in a composition encompassed herein. In an embodiment, the grind size of the ground nuts can be manipulated in order to obtain a ground nut base having one or more desired properties. In an embodiment, the grind size of ground nuts is determined using a grind gauge. In an embodiment, the grind size of ground nuts provides a reading of about six half mil on an Hegman gauge using the method of ASTM D-1210. In an embodiment, a measurement made using a Hegman gauge (ASTM D-1210), material to be measured is distributed uniformly by drawing a straight-edged scraper from the deep end of the gauge to the shallow end of the gauge. Particles or agglomerates too large to pass between the moving scraper and the gauge path are revealed as “scratches” or “points”. Where the scratches or points occur is read directly on the calibrated gauge shoulder. The scale used for Hegman gauge measurements is half mil.

In an embodiment, the grind size of a ground nut base is from about 1 half mil to about 15 half mil. In an embodiment, the grind size of a ground nut base is from about 2 half mil to about 13 half mil, from about 3 half mil to about 11 half mil, from about 3 half mil to about 9 half mil, from about 4 half mil to about 8 half mil, from about 5 half mil to about 7 half mil. In an embodiment, the grind size of a ground nut base is about 1 half mil, about 2 half mil, about 3 half mill, about 4 half mil, about 5 half mil, about 6 half mil, about 7 half mil, about 8 half mil, about 9 half mil, about 10 half mil, about 11 half mil, about 12 half mil, about 13 half mil, about 14 half mil, or about 15 half mil. In an embodiment, the grind size of a ground nut base is about at least 1 half mil, about at least 2 half mil, about at least 3 half mill, about at least 4 half mil, about at least 5 half mil, about at least 6 half mil, about at least 7 half mil, about at least 8 half mil, about at least 9 half mil, about at least 10 half mil, about at least 11 half mil, about at least 12 half mil, about at least 13 half mil, about at least 14 half mil, or about at least 15 half mil. In an embodiment, the grind size of a ground nut base is about less than 1 half mil, about less than 2 half mil, about less than 3 half mill, about less than 4 half mil, about less than 5 half mil, about less than 6 half mil, about less than 7 half mil, about less than 8 half mil, about less than 9 half mil, about less than 10 half mil, about less than 11 half mil, about less than 12 half mil, about less than 13 half mil, about less than 14 half mil, or about less than 15 half mil.

As will be understood by one of skill in the art, the size, shape, and physical properties (e.g., amount of oil released from the nut) of a ground nut base may vary based on the type of grinding apparatus used. Any type of suitable grinding mill or apparatus may be used to grind the nuts. As will be understood by the skilled artisan, different mills may impart different, specific properties to a ground nut base, and the skilled artisan will understand how to select an appropriate mill (e.g., rotor-stator mill having milling surfaces oriented axially, rotor-stator mill having milling surfaces oriented radially, etc. . . . ) to obtain desired properties. By way of a non-limiting example, the milling action on peanut, and optionally, other ingredients, is determined by the design or the physical pattern on the milling plate surfaces, and/or by the closeness of the setting of the milling plates with respect to one another. In an embodiment, increasing the grind size on a mill can have the effect of increasing the viscosity and/or density of a ground nut composition. In an embodiment, increasing the grind size on a mill contributes to a more even distribution of inclusions in a ground nut composition encompassed herein. In an embodiment, increasing the grind size on a mill contributes to a distribution of inclusions wherein the distribution of inclusions is substantially the same in a proximal third, a middle third, and a distal third of the packaged ground nut composition.

In an embodiment, a ground nut base is prepared to have a density that is about the same as the density of the inclusions added to the ground nut composition. In an embodiment, preparing a ground nut base to have a density about the same as the density of the inclusions added to the ground nut composition contributes to a more even distribution of the inclusions within the ground nut composition. In an aspect of one embodiment, a packaged ground nut composition is prepared such that the ground nut base has a density that is about the same as the density of the inclusions in the packaged ground nut composition. In another embodiment, inclusions to be added to a ground nut base are selected to have a density about the same as the ground nut base to which the inclusions will be added. In an embodiment, selecting inclusions having a density about the same as the ground nut base to which the inclusions will be added contributes to a more even distribution of the inclusions within the ground nut composition. In an embodiment, selecting inclusions having a density about the same as the ground nut base to which the inclusions will be added contributes to the inclusions having substantially the same distribution in a proximal third, a middle third, and a distal third of a packaged ground nut composition. In an aspect of one embodiment, a packaged ground nut composition is prepared by selecting inclusions having a density that is about the same as the density of the ground nut base of the packaged ground nut composition.

In an embodiment, density of a ground nut composition can be measured by use of a picnometer. In an embodiment, density of an inclusion can be measured by use of an oil displacement method. Based on the disclosure set forth herein, the skilled artisan will understand how to identify a method of density measurement useful for the compositions and methods encompassed herein.

In an embodiment, a ground nut composition has a density of about 0.5 g/ml to about 3 g/ml. In an embodiment, a ground nut composition has a density of about 0.75 g/ml to about 2.5 g/ml, about 1 g/ml to about 2.25 g/ml, about 1.25 g/ml to about 2 g/ml, about 1.5 g/ml to about 1.75 g/ml, or about 1.15 g/ml to about 1.25 g/ml. In an embodiment, a ground nut composition has a density of about 0.5 g/ml, about 0.75 g/ml, about 1 g/ml, about 1.25 g/ml, about 1.5 g/ml, about 1.75 g/ml, about 2 g/ml, about 2.25 g/ml, about 2.5 g/ml. about 2.75 g/ml, or about 3 g/ml. In an embodiment, a ground nut composition has a density of about at least 0.5 g/ml, about at least 0.75 g/ml, about at least 1 g/ml, about at least 1.25 g/ml, about at least 1.5 g/ml, about at least 1.75 g/ml, about at least 2 g/ml, about at least 2.25 g/ml, about at least 2.5 g/ml. about at least 2.75 g/ml, or about at least 3 g/ml. In an embodiment, a ground nut composition has a density of about less than 0.5 g/ml, about less than 0.75 g/ml, about less than 1 g/ml, about less than 1.25 g/ml, about less than 1.5 g/ml, about less than 1.75 g/ml, about less than 2 g/ml, about less than 2.25 g/ml, about less than 2.5 g/ml. about less than 2.75 g/ml, or about less than 3 g/ml.

In an embodiment, an inclusion has a density of about 0.25 g/ml to about 3 g/ml. In an embodiment, an inclusion has a density of about 0.5 g/ml to about 2.75 g/ml. In an embodiment, an inclusion has a density of about 0.75 g/ml to about 2.5 g/ml, about 1 g/ml to about 2.25 g/ml, about 1.25 g/ml to about 2 g/ml, about 1.5 g/ml to about 1.75 g/ml, or about 1.15 g/ml to about 1.25 g/ml. In an embodiment, an inclusion has a density of about 0.25 g/ml, about 0.5 g/ml, about 0.75 g/ml, about 1 g/ml, about 1.25 g/ml, about 1.5 g/ml, about 1.75 g/ml, about 2 g/ml, about 2.25 g/ml, about 2.5 g/ml. about 2.75 g/ml, or about 3 g/ml. In an embodiment, an inclusion has a density of about at least 0.25 g/ml, about at least 0.5 g/ml, about at least 0.75 g/ml, about at least 1 g/ml, about at least 1.25 g/ml, about at least 1.5 g/ml, about at least 1.75 g/ml, about at least 2 g/ml, about at least 2.25 g/ml, about at least 2.5 g/ml. about at least 2.75 g/ml, or about at least 3 g/ml. In an embodiment, an inclusion has a density of about less than 0.25 g/ml, about less than 0.5 g/ml, about less than 0.75 g/ml, about less than 1 g/ml, about less than 1.25 g/ml, about less than 1.5 g/ml, about less than 1.75 g/ml, about less than 2 g/ml, about less than 2.25 g/ml, about less than 2.5 g/ml. about less than 2.75 g/ml, or about less than 3 g/ml.

In addition to varying the grind size of a ground nut base, the viscosity of a ground nut base can be modified in other ways. In one embodiment, the viscosity of a ground nut base is modified by adding various ingredients to the ground nut base. In an embodiment, the viscosity of a ground nut base can be modified by adding a stabilizer. In an embodiment, adding a stabilizer to a ground nut base increases the viscosity of the ground nut base. In an aspect of an embodiment, adding a stabilizer to a ground nut base to increase the viscosity of a ground nut base contributes to a more even distribution of inclusions added to the ground nut base to form a ground nut composition. In an embodiment, adding a stabilizer to a ground peanut base to increase the viscosity of a ground peanut base contributes to a distribution of inclusions in a packaged ground peanut composition comprising the base, wherein the distribution of inclusions in a proximate third, a middle third, and a distal third of the packaged ground peanut composition is substantially the same.

In an embodiment, the viscosity of a ground nut composition can be measured. In an embodiment, the viscosity of a ground nut base can be measured. Viscosity can be measured for evaluation of a composition as encompassed herein, using any technique known to the skilled artisan. In an embodiment, the viscosity is a Casson plastic viscosity, or a Casson yield value. In an embodiment, the viscosity is measured as Brookfield viscosity. In an embodiment, the Brookfield viscosity is measured at a temperature of 85 degrees Celsius after 60 seconds at 20 rpm using a spindle D, heliopath. In an embodiment, a ground nut base has a Brookfield viscosity of about 3,400 measured at a temperature of 85 degrees Celsius after 60 seconds at 20 rpm using a spindle D, heliopath. In an embodiment, a ground peanut base has a Brookfield viscosity of about 3,400 measured at a temperature of 85 degrees Celsius after 60 seconds at 20 rpm using a spindle D, heliopath.

As discussed in detail elsewhere herein, a ground nut base may comprise one or more additional ingredients, such as, but not limited to, a stabilizer, and a flavorant, such as salt or sugar. In an embodiment, the viscosity of a ground nut base is measured before the addition of any additional ingredients. In an embodiment, the viscosity of a ground nut base is measured after the addition of one or more additional ingredients. In an embodiment, the viscosity of a ground nut base is measured after the addition of all additional ingredients, but before the addition of any inclusions. In an embodiment, a ground peanut base comprising stabilizer, salt and sugar has a Brookfield viscosity of about 3,400 measured at a temperature of 85 degrees Celsius after 60 seconds at 20 rpm using a spindle D, heliopath. In an aspect of an embodiment, the stabilizer is a fully hydrogenated vegetable oil comprising rapeseed, cottonseed, and soybean oils.

In an embodiment, the Brookfield viscosity of a ground nut base measured at a temperature of 85 degrees Celsius after 60 seconds at 20 rpm using a spindle D, heliopath, is about 2,500, about 2,600, about 2,700, about 2,800, about 2,900, about 3,000, about 3,100, about 3,200, about 3,300, about 3,400, about 3,500, about 3,600, about 3,700, about 3,800, about 3,900, about 4,000, about 4,100, about 4,200, about 4,300, about 4,400, or about 4,500. In an embodiment, the Brookfield viscosity of a ground nut base measured at a temperature of 85 degrees Celsius after 60 seconds at 20 rpm using a spindle D, heliopath, is about at least 2,500, about at least 2,600, about at least 2,700, about at least 2,800, about at least 2,900, about at least 3,000, about at least 3,100, about at least 3,200, about at least 3,300, about at least 3,400, about at least 3,500, about at least 3,600, about at least 3,700, about at least 3,800, about at least 3,900, about at least 4,000, about at least 4,100, about at least 4,200, about at least 4,300, about at least 4,400, or about at least 4,500. In an embodiment, the Brookfield viscosity of a ground nut base measured at a temperature of 85 degrees Celsius after 60 seconds at 20 rpm using a spindle D, heliopath, is about less than 2,500, about less than 2,600, about less than 2,700, about less than 2,800, about less than 2,900, about less than 3,000, about less than 3,100, about less than 3,200, about less than 3,300, about less than 3,400, about less than 3,500, about less than 3,600, about less than 3,700, about less than 3,800, about less than 3,900, about less than 4,000, about less than 4,100, about less than 4,200, about less than 4,300, about less than 4,400, or about less than 4,500. In an embodiment, the Brookfield viscosity of a ground nut base measured at a temperature of 85 degrees Celsius after 60 seconds at 20 rpm using a spindle D, heliopath, is from about 2,500 to about 4,500, from about 2,750 to about 4,250, from about 3,000 to about 4,000, or from about 3,250 to about 3,750.

In an embodiment, the viscosity of a ground nut base is measured after the addition of additional ingredients and the addition of inclusions. In other words, the viscosity of the ground nut composition as disclosed herein is measured. In an embodiment, in an embodiment, the viscosity of the packaged ground nut composition is measured. In an embodiment, the Brookfield viscosity of a ground nut composition measured at a temperature of 85 degrees Celsius after 60 seconds at 20 rpm using a spindle D, heliopath, is about 6,000, about 6,500, about 7,000, about 7,500, about 8,000, about 8,500, about 9,000, about 9,500, about 10,000, about 10,500, about 11,000, about 11,500, about 12,000, about 12,500, about 13,000, about 13,500, about 14,000, about 14,500, or about 15,000.

In various embodiments, the particle size distribution of the ground nut base can be evaluated prior to the addition of inclusions, or after inclusions are removed from the packaged ground nut composition. In an embodiment, the particle size distribution of the ground nut base may be monomodal or bimodal. In an embodiment, the particle size distribution of a ground nut base is bimodal. In an embodiment, the particle size distribution of a ground peanut base is bimodal. In an embodiment, the particle size distribution of a ground peanut base comprising stabilizer, salt, and sugar is bimodal. In an embodiment, the particle size distribution analysis is conducted on total particles, including water soluble solids and water insoluble solids. In an embodiment, the particle size distribution analysis is conducted on only the water insoluble solids from a ground peanut base. In an embodiment, the particle size distribution of all particles, including water soluble solids and water insoluble solids, of a ground peanut base is bimodal, with D₁₀ of 1.19 μm, D₅₀ of 13.13 μm, and D₉₀ of 48.48 μm, with a span of about 3.60. In an embodiment, the particle size distribution of all particles, including water soluble solids and water insoluble solids, of a ground peanut base is bimodal, with D₁₀ of about 2 μm, D₅₀ of about 15 μm, and D₉₀ of about 50 μm, with a span of about 3 to about 4. In an embodiment, the particle size distribution of all particles, including water soluble solids and water insoluble solids, of a ground peanut base is bimodal, with D10 of about 1.17 μn, D50 of about 14.31 μm, and D90 of about 50.05 μm, with a span of about 3.42. In an embodiment, the particle size distribution of all particles, including water soluble solids and water insoluble solids, of a ground peanut base is bimodal, with D10 of about 1.17 μm, D50 of about 13.77 μm, and D90 of about 51.25 μm, with a span of about 3.64. In an embodiment, the particle size distribution of all particles, including water soluble solids and water insoluble solids, of a ground peanut base is bimodal, with D10 of about 1.19 μm, D50 of about 14.31 μm, and D90 of about 52.55 μm, with a span of about 3.59.

In an embodiment, the particle size measurement is made using a Horiba LA-900 Laser Scattering Particle Size Distribution Analyzer.

In various embodiments, the particle size distribution of the inclusions can be determined using any method known in the art to be suitable for particles the size of the inclusions of interest. In an embodiment, inclusion particle sizes are determined using one or more sieves of various sizes. In an embodiment, the particle size distribution is determined for an inclusion composition comprising 60% midget raisins, 30% rice granola, and 10% peanut chunks. The inclusion composition is dried, blended, and passed through a set of sieves, resulting in a particle size distribution determined to be about 9.5% of particles retained on a 9.5 mm sieve, about 15.6% retained on an 8.7 mm sieve, about 46.5% retained on a 6.7 mm sieve, about 20.5% retained on a 4.75 mm sieve, about 13.5% retained on a 2 mm sieve, and about 0.8% of the particles being under 2 mm. In an embodiment, the particle size distribution is determined for all particles in a packaged ground nut composition comprising an inclusion composition that comprises 60% midget raisins, 30% rice granola, and 10% peanut chunks, distributed in a ground peanut base comprising a stabilizer and flavorants. In an embodiment, the particle size distribution for the packaged ground nut composition is calculated to have a particle size distribution determined to be about 0.6% retained on a 9.5 mm sieve, about 3.1% retained on an 8.7 mm sieve, about 9.3% retained on a 6.7 mm sieve, about 4.1% retained on a 4.75 mm sieve, about 2.7% retained on a 2 mm sieve, and about 80.2% of the particles being under 2 mm.

Methods

In an embodiment, encompassed herein is a method of producing a packaged ground nut composition having inclusions being substantially evenly distributed in the packaged ground nut composition. In an embodiment, a method is provided for producing a packaged ground nut composition having inclusions, the inclusions having substantially the same distribution in a proximal third, a middle third, and a distal third of the packaged ground nut composition. In an embodiment, the method is a method of producing a packaged ground peanut composition made using a ground peanut base.

It will be understood that the methods encompassed herein encompass the use of any compositions described herein and/or encompassed by the present disclosure. The methods encompassed herein also encompass the preparation of any compositions described herein and/or encompassed by the present disclosure.

In an embodiment, a method is designed to minimize the sinking of inclusions to the bottom of a package upon addition of the inclusions to a ground nut base used in the preparation of a packaged ground nut composition. In an embodiment, a method is designed to prevent the sinking of inclusions to the bottom of a package upon addition of the inclusions to a ground nut base used in the preparation of a packaged ground nut composition. In an embodiment, a method is designed to decrease the occurrence of inclusions sinking to the bottom of a package upon addition of the inclusions to a ground nut base used in the preparation of a packaged ground nut composition. In an embodiment, a method is designed to minimize or prevent the sinking of inclusions to the bottom of a package of a packaged ground nut composition.

In an embodiment, a method of producing a packaged ground nut composition having inclusions being substantially evenly distributed in the packaged ground nut composition comprises forming a fluid base comprising ground nuts, cooling the fluid base, blending into the cooled fluid base one or more inclusions, and packaging the ground nut composition to form a packaged ground nut composition having inclusions that are substantially evenly distributed in the packaged ground nut composition, the packaged ground nut composition having substantially the same distribution of inclusions in the proximal third, middle third, and distal third of the ground nut composition as packaged. In an embodiment, the ground nut composition is a nut spread. In an embodiment, the ground nut composition is a peanut spread.

In an embodiment, the process of preparing a composition encompassed by the present disclosure optionally includes modification of the ingredients of a ground nut composition in order to optimize the desired properties and characteristics of a ground nut composition. In an embodiment, the viscosity of a ground nut base is adjusted in order to more evenly distribute the inclusions in a ground nut composition, such as a packaged ground nut composition. In an embodiment, the viscosity of a ground nut base is increased in order to more evenly distribute the inclusions in a ground nut composition. In an embodiment, the viscosity of a ground nut base is increased by addition of one or more stabilizers to the ground nut base. In an embodiment, the viscosity of a ground nut base is increased by addition of a hydrogenated oil. In an embodiment, the viscosity of a ground nut base is increased by addition of a hydrogenated oil such that a packaged ground nut composition prepared using the ground nut base has substantially the same distribution of inclusions in the proximal third, middle third, and distal third of the ground nut composition as packaged.

In an embodiment, the process of preparing a composition encompassed by the present disclosure optionally includes modification of the ingredients of a ground nut composition as well as the process of making the ground nut composition in order to optimize the desired properties and characteristics of a ground nut composition. In an embodiment, the grind size of the nuts in the ground nut base is adjusted in order to more evenly distribute the inclusions in a ground nut composition, such as a packaged ground nut composition. In an embodiment, the grind size is adjusted so that the viscosity of the resulting ground nut base is increased in order to more evenly distribute the inclusions in a ground nut composition. In an embodiment, the grind size is increased. In an embodiment, the grind size is adjusted so that a packaged ground nut composition prepared using the ground nut base has substantially the same distribution of inclusions in the proximal third, middle third, and distal third of the ground nut composition as packaged.

In an embodiment, the process of preparing a composition encompassed by the present disclosure optionally includes modification of the process in order to optimize the desired properties and characteristics of a ground nut composition. In an embodiment, the temperature of the ground nut base at which the inclusions are added to the ground nut base is adjusted in order to result in a more even distribution of inclusions in a ground nut composition, such as a packaged ground nut composition. In an embodiment, the temperature of the ground nut base at which inclusions are added to the ground nut base is adjusted so that the viscosity of the resulting ground nut base is increased in order to more evenly distribute the inclusions in a ground nut composition. In an embodiment, the temperature of a ground nut base at which inclusions are added to the ground nut base is lower than a temperature at which a ground peanut processing stream is typically filled into a package. In an embodiment, the temperature of a ground nut base at which inclusions are added to the ground nut base is about 5 degrees F. lower than the temperature at which the inclusion-containing ground nut composition is filled into a package. In an embodiment, the temperature of the inclusions added to a ground nut base is adjusted so that the addition of the inclusions to the ground nut base does not substantially alter the temperature of the ground nut base.

In an embodiment, the temperature of the ground nut base at which inclusions are added to a ground nut base is between about 95 degrees F. and about 115 degrees F. In an embodiment, the temperature of the ground nut base at which inclusions are added to a ground nut base is between about 90 degrees F. and about 110 degrees F. In an embodiment, inclusions are added to a ground nut base at a ground nut base temperature between about 97 degrees F. and about 112 degrees F. In an embodiment, inclusions are added to a ground nut base at a ground nut base temperature between about 92 degrees F. and about 107 degrees F. In an embodiment, inclusions are added to a ground nut base at a ground nut base temperature between about 94 degrees F. and about 104 degrees F., between about 95 degrees F. and about 101 degrees F., or between about 96 degrees F. and about 99 degrees F. In an embodiment, the temperature of the ground nut base at which the inclusions are added to the ground nut base is adjusted so that a packaged ground nut composition prepared in such a manner has substantially the same distribution of inclusions in the proximal third, middle third, and distal third of the ground nut composition as packaged. In an embodiment, the temperature of the inclusions added to the ground nut base is adjusted so that a packaged ground nut composition prepared in such a manner has substantially the same distribution of inclusions in the proximal third, middle third, and distal third of the ground nut composition as packaged.

In another embodiment, a ground nut composition product stream comprising inclusions is recirculated in order to result in a more even distribution of inclusions in a ground nut composition, such as a packaged ground nut composition. In an embodiment, a ground nut composition product stream comprising inclusions is recirculated in order to result in a more even distribution of inclusions in a ground nut composition, in part, by facilitating equilibrium of the processing equipment.

In one embodiment, a method of producing a packaged nut spread having inclusions being substantially evenly distributed in the packaged nut spread comprises forming a fluid base comprising about 60 wt % to about 90 wt % ground nuts having a grind size of about six half mil as measured using a Hegman gauge and the method of ASTM D-1210, about 0 wt % to about 8 wt % sweetener, about 0 wt % to about 5 wt % salt, and about 0 wt % to about 3 wt % stabilizer. The method further comprises cooling the fluid base to about 96 degrees F. to about 105 degrees F., blending into the cooled fluid base inclusions having a density that is about the same as a density of the ground nuts, and packaging the nut spread with inclusions to form a packaged nut spread having inclusions that are substantially evenly distributed in the packaged nut spread such that the packaged nut spread has substantially the same distribution of inclusions in the proximal third, middle third, and distal third of the nut spread as packaged. In an embodiment, the nut spread is a peanut spread.

In one embodiment, a method of producing a packaged nut spread having inclusions being substantially evenly distributed in the packaged nut spread comprises forming a fluid base comprising about 60 wt % to about 90 wt % ground nuts having a grind size of about six half mil as measured using a Hegman gauge and the method of ASTM D-1210, about 7 wt % to about 8 wt % sweetener, about 1 wt % to about 2 wt % salt, and about 1 wt % to about 2 wt % stabilizer. The method further comprises cooling the fluid base to about 96 degrees F. to about 105 degrees F., blending into the cooled fluid base inclusions having a density that is about the same as a density of the ground nuts, and packaging the nut spread with inclusions to form a packaged nut spread having inclusions that are substantially evenly distributed in the packaged nut spread such that the packaged nut spread has substantially the same distribution of inclusions in the proximal third, middle third, and distal third of the nut spread as packaged. In an embodiment, the nut spread is a peanut spread.

In an embodiment, a method of producing a packaged ground nut composition encompassed herein produces a ground nut base having a particle size distribution with a span of about 3 to about 4, such that at least 90% of the particles are smaller than about 50 microns, at least 50% of the particles are smaller than about 15 microns, and about 10% of the particles are smaller than about 2 microns. In an embodiment, a method of producing a packaged ground nut composition encompassed herein produces a ground nut composition having inclusions with a particle size distribution of about 1% to about 5% of inclusions retained on a 9.5 mm sieve, about 10% to about 20% of inclusions retained on an 8.7 mm sieve, about 40% to about 50% of inclusions retained on a 6.7 mm sieve, and about 15% to about 25% of inclusions retained on a 9.5 mm sieve. In an embodiment, a method of producing a packaged ground nut composition encompassed herein produces a ground nut composition having a Brookfield viscosity from about 6,000 to about 14,000 centipoise measured at a temperature of 85 degrees C. after 60 seconds at 20 rpm with a spindle D, heliopath. In an embodiment, the nut is a peanut. In an embodiment, the ground nut composition is a peanut spread.

In another embodiment, a process of making a packaged ground nut composition comprises adjustment of the mixing step for blending inclusions with the ground nut base. In an embodiment, the mixing step comprises addition of inclusions to a fluid ground nut base. In an embodiment, the mixing step comprises a continuous flow mixer. In an embodiment, a mixing step comprises the use of a screw-type mixer for blending inclusions with a ground nut base. In an embodiment, inclusions are added to the ground nut base using one or more weigh belt feeders. In an embodiment, a mixing step comprises the use of gentle mixing of the ground nut composition in order to maintain the physical integrity of inclusions upon addition of the inclusions to a ground nut base. In an embodiment, gentle mixing comprises the use of low rpm mixing of the ground nut composition. In an embodiment, the inclusions are added to a fluid ground nut base by way of a continuous flow mixer operating at about 100 rpm or less. In an embodiment, the inclusions are added to a fluid ground nut base by way of a continuous flow mixer operating at about 75 rpm or less, about 50 rpm or less, about 25 rpm or less, about 20 rpm or less, about 15 rpm or less, about 10 rpm or less, or about 5 rpm or less. In an embodiment, the inclusions are added to a fluid ground nut base by way of a continuous flow mixer operating at about 75 rpm, about 50 rpm, about 25 rpm, about 20 rpm, about 15 rpm, about 10 rpm, or about 5 rpm. In an embodiment, the mixing step comprises the use of a continuous slurry mixer. In an embodiment, the mixing step comprises the use of an apparatus typically used for feeding of ice cream ingredients into a product.

In an embodiment, the mixing step comprises the use of a temperature-controlled mixer. As will be understood based on the disclosure encompassed herein, a temperature-controlled mixer may be used, in part, to produce a packaged ground nut composition having substantially the same distribution of inclusions in the proximal third, middle third, and distal third of the ground nut composition as packaged. In an embodiment, the mixing step comprises the use of a temperature-controlled mixer, in part, to reduce or eliminate temperature loss of the mixture contained therein, to stabilize the temperature of the mixture contained therein, to improve consistency of the mixing process, to minimize or eliminate process variance with regard to the final mixed product, and/or to improve the quality of the finished product (e.g., to optimize the substantially equal distribution of inclusions in the proximal third, middle third, and distal third of the ground nut composition as packaged).

In an embodiment, the process of making a packaged ground nut composition comprises adjustment of the mixing step such that the inclusions maintain the same particle size immediately after addition to the fluid base. In an embodiment, the process of making a packaged ground nut composition comprises adjustment of the mixing step such that at least 75% of the inclusions maintain the same particle size immediately after addition to the fluid base. In an embodiment, the inclusions are added to the fluid base using a continuous flow mixer operating at a setting such that about at least 75% of the inclusions maintain the same particle size immediately after addition to the fluid base. The skilled artisan will understand how to ascertain the particle size of the inclusions based on the disclosure set forth herein.

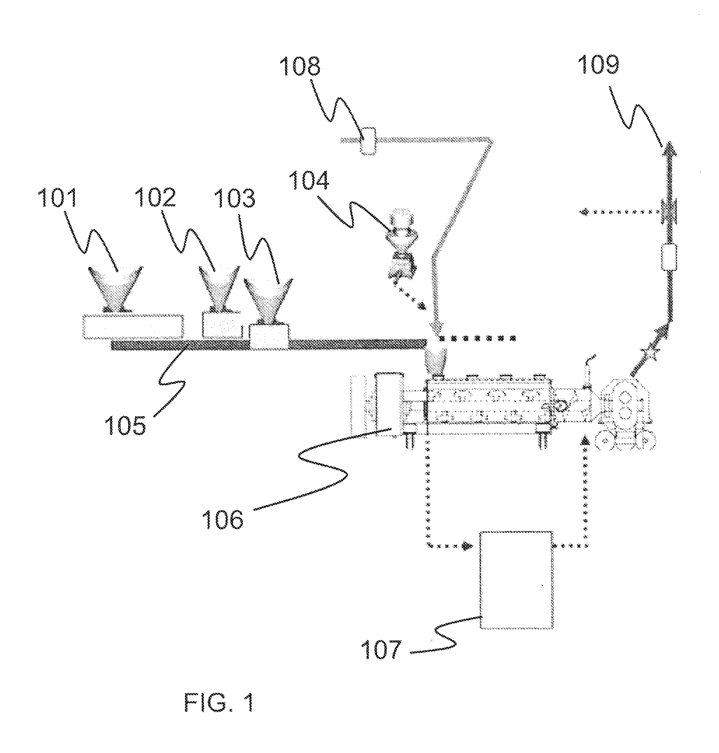

Referring now to FIG. 1, in an embodiment, a ground nut base is prepared as described herein 108 prior to addition of any inclusion 101, and optionally, any second 102 or third 103 inclusions to the ground nut base. Inclusions are combined with the ground nut stream by way of a weight belt feeder 105. At least one flavorant 104 is also optionally added to the ground nut base, and the entire ground nut composition is then subjected to mixing in a continuous slurry mixer 106. The continuous slurry mixer 106 optionally comprises a jacketed heating/cooling apparatus 107. The mixed ground nut composition is then transferred to a filler apparatus 109.

The invention is further described by the following examples. It should be recognized that variations based on the inventive features are within the skill of the ordinary artisan, and that the scope of the invention should not be limited by the examples. To properly determine the scope of the invention, an interested party should consider the claims herein, and any equivalent thereof. In addition, all citations herein are incorporated by reference, and unless otherwise expressly stated, all percentages are by weight.

### Example 1

### Ground Nut Compositions

The following compositions were prepared using various embodiments of the compositions and methods encompassed herein:

A.

| | PERCENT WEIGHT OF |
|---|---|
| INGREDIENT | COMPOSITION |
| Glycerated Raisins | 8.00 |
| Cinnamon granola | 1.50 |
| Cinnamon | 1.13 |
| Peanut inclusions | 12.13 |
| Ground peanuts (for nut base) | 68.40 |
| Stabilizer (fully hydrogenated oil | 1.45 |
| comprising rapeseed, cottonseed, | |
| and soybean oil) | |
| Powdered sugar (6x) | 6.40 |
| Salt | 1.00 |
| | 100% total |

B.

| | PERCENT WEIGHT OF |
|---|---|
| INGREDIENT | COMPOSITION |
| Air-dried banana | 2.00 |
| Banana-flavored granola | 2.00 |
| Banana flavor | 0.50 |
| Peanut inclusions | 13.00 |
| Ground peanuts (for nut base) | 73.80 |
| Stabilizer (fully hydrogenated oil | 1.45 |
| comprising rapeseed, cottonseed, | |
| and soybean oil) | |
| Powdered sugar (6x) | 6.25 |
| Salt | 1.00 |
| | 100% total |

C.

| | PERCENT WEIGHT OF |
|---|---|
| INGREDIENT | COMPOSITION |
| Orange-infused cranberries - | 10.00 |
| glycerated | |
| Glycerated cranberries | 6.15 |
| Peanut inclusions | 4.00 |
| Ground peanuts (for nut base) | 71.50 |
| Stabilizer (fully hydrogenated oil | 1.45 |
| comprising rapeseed, cottonseed, | |
| and soybean oil) | |
| Powdered sugar (6x) | 5.90 |
| Salt | 1.00 |
| | 100% total |

### Example 2

### Viscosity of Ground Nut Compositions

The following compositions were prepared using various embodiments of the compositions and methods encompassed herein:

A. Brookfield Viscosity: 6,400 cp (spindle D heliopath, 20 rpm, measured at 85 degrees C.)

| | PERCENT WEIGHT OF |
|---|---|
| INGREDIENT | COMPOSITION |
| Air-dried banana | 3.00 |
| Banana-flavored granola | 5.00 |
| Banana flavor | 0.20 |
| Peanut inclusions | 2.00 |
| Ground peanuts (for nut base) | 80.85 |
| Stabilizer (fully hydrogenated oil | 1.45 |
| comprising rapeseed, cottonseed, | |
| and soybean oil) | |
| Powdered sugar (6x) | 6.50 |
| Salt | 1.00 |

B. Brookfield Viscosity: 13,150 cp (spindle D heliopath, 20 rpm, measured at 85 degrees C.)

| | PERCENT WEIGHT OF |
|---|---|
| INGREDIENT | COMPOSITION |
| Dried cranberries | 9.00 |
| Flavor-infused cranberries | 10.00 |
| Peanut inclusions | 4.00 |
| Ground peanuts (for nut base) | 60.85 |
| Stabilizer (fully hydrogenated oil | 1.45 |
| comprising rapeseed, cottonseed, | |
| and soybean oil) | |
| Powdered sugar (6x) | 6.50 |
| Salt | 1.00 |

### Example 3

### Particle Size Distribution for Ground Nut Base

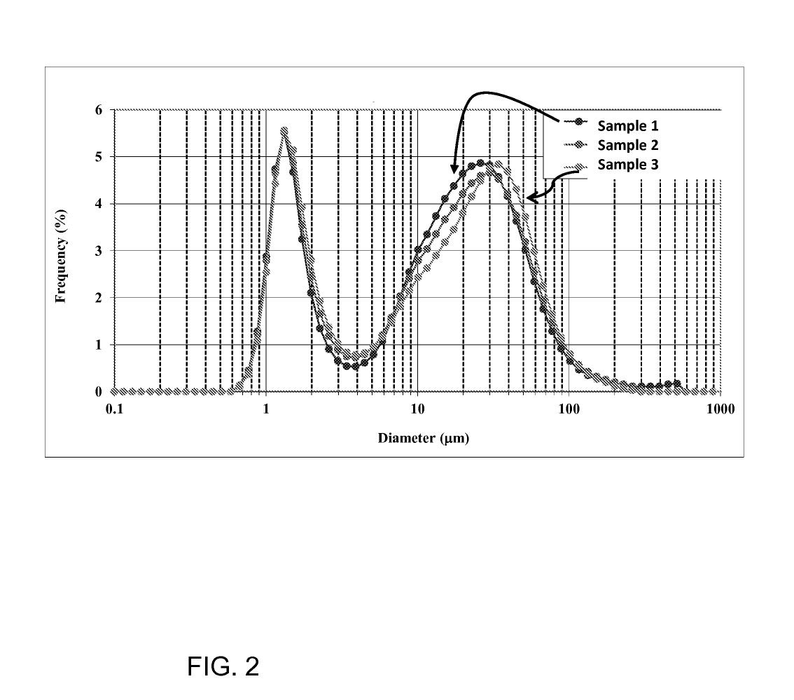

The particle size distribution for the ground nut base portion of ground nut compositions encompassed herein was measured. Ground nut compositions comprising inclusions were melted by heating the compositions to 150 degrees Fahrenheit to 170 degrees Fahrenheit, the melted composition passed through a sieve of 20 or 30 mesh to remove the large particulate inclusions, and the portion of the composition passing through the mesh then dispersed in Neobee Oil. The particle size distribution was determined on the dispersed sample using a Horiba LA-900 Laser Scattering Particle Size Distribution Analyzer. FIG. 2 illustrates the particle size distribution for three separate samples prepared according to the methods and compositions encompassed herein. The ground nut composition of Sample 1 originally included raisins, the ground nut composition of Sample 2 originally included cinnamon, raisins, and nuts, and the ground nut composition of Sample 3 originally included raisins and nuts.

For Sample 1, the particle size distribution of all particles, including water soluble solids and water insoluble solids, of a ground peanut base is bimodal, with D₁₀ of 1.17 μm, D₅₀ of 14.31 μm, and D₉₀ of 50.05 μn, with a span of 3.42. For Sample 2, the particle size distribution of all particles, including water soluble solids and water insoluble solids, of a ground peanut base is bimodal, with D₁₀ of 1.17 μm, D₅₀ of 13.77 μm, and D₉₀ of 51.25 μm, with a span of 3.64. For Sample 3, the particle size distribution of all particles, including water soluble solids and water insoluble solids, of a ground peanut base is bimodal, with D₁₀ of 1.19 μm, D₅₀ of 14.31 μm, and D₉₀ of 52.55 μm, with a span of 3.59.

It will be appreciated by those skilled in the art that changes could be made to the exemplary embodiments shown and described above without departing from the broad inventive concept thereof. It is understood, therefore, that this invention is not limited to the exemplary embodiments shown and described, but it is intended to cover modifications within the spirit and scope of the present invention as defined by the claims. For example, specific features of the exemplary embodiments may or may not be part of the claimed invention and features of the disclosed embodiments may be combined. Unless specifically set forth herein, the terms “a”, “an” and “the” are not limited to one element but instead should be read as meaning “at least one”.

The term “about” as used herein refers to a value that is +/−10% of the value to which it refers, unless otherwise defined in any particular embodiment or example. By way of a non-limiting example, the term “about 50% water” refers to an amount of water ranging from 45% to 55%.

It is to be understood that at least some of the descriptions of the invention have been simplified to focus on elements that are relevant for a clear understanding of the invention, while eliminating, for purposes of clarity, other elements that those of ordinary skill in the art will appreciate may also comprise a portion of the invention. However, because such elements are well known in the art, and because they do not necessarily facilitate a better understanding of the invention, a description of such elements is not provided herein.

Further, to the extent that the method does not rely on the particular order of steps set forth herein, the particular order of the steps should not be construed as limitation on the claims. The claims directed to the method of the present invention should not be limited to the performance of their steps in the order written, and one skilled in the art can readily appreciate that the steps may be varied and still remain within the spirit and scope of the present invention.

We claim:

1. A packaged nut spread comprising:
a.) a base including:
about 60 wt % to about 90 wt % ground nuts having a grind size of about six half mil as measured using a Hegman gauge and the method of ASTM D-1210;
about 0 wt % to about 8 wt % sweetener;
about 0 wt % to about 5 wt % salt; and
about 0 wt % to about 3 wt % stabilizer, and
b.) about 5 wt % to about 30 wt % inclusions having a density that is about the same as the density of the ground nuts, the inclusions being substantially evenly distributed in the packaged nut spread, the packaged nut spread having substantially the same distribution of inclusions in a proximal third, a middle third, and a distal third of the nut spread as packaged.

2. The packaged nut spread of claim 1, wherein the base has a particle size distribution with a span of about 3 to about 4, such that at least 90% of the particles are smaller than about 50 microns, at least 50% of the particles are smaller than about 15 microns, and about 10% of the particles are smaller than about 2 microns.

3. The packaged nut spread of claim 1, wherein the inclusions have a particle size distribution of about 1% to about 5% of inclusions retained on a 9.5 mm sieve, about 10% to about 20% of inclusions retained on an 8.7 mm sieve, about 40% to about 50% of inclusions retained on a 6.7 mm sieve, and about 15% to about 25% of inclusions retained on a 4.75 mm sieve.

4. The packaged nut spread of claim 1, wherein the packaged nut spread has a Brookfield viscosity from about 6,000 to about 14,000 centipoise measured at a temperature of 85 degrees C. after 60 seconds at 20 rpm with a spindle D, heliopath.

5. The packaged nut spread of claim 1 further comprising crushable inclusions, wherein the crushable inclusions are substantially uncrushed.

6. The packaged nut spread of claim 1 wherein the inclusions include granola.

7. The packaged nut spread of claim 1 wherein all of the inclusions are readily crushable to particle sizes less than ¼ inch.

8. The packaged nut spread of claim 1 wherein all of the inclusions are readily crushable to particle sizes less than ⅛ inch.

9. The packaged nut spread of claim 1 wherein the inclusions include glycerated fruit.

10. The packaged nut spread of claim 1 wherein the inclusions include confectionary taken from the group consisting of sugar coated chocolate and compound coating chocolate flavored pieces and combinations thereof.

11. The packaged nut spread of claim 1 wherein the inclusions are taken from the group consisting of granola, fruit pieces, confectionary pieces, nut pieces and combinations thereof.

12. The packaged nut spread of claim 1 wherein the base further comprises:
about 0 wt % to about 2 wt % spice;
about 0 wt % to about 2 wt % flavoring;
about 0 wt % to about 12 wt % soybean oil;
about 0 wt % to about 7 wt % corn dextrin; and
wherein the sweetener is powdered sugar and the ground nuts are roasted Runner peanuts.

13. A method of producing a packaged nut spread having inclusions being substantially evenly distributed in the packaged nut spread, the method comprising:
a.) forming a fluid base comprising about 60 wt % to about 90 wt % ground nuts having a grind size of six half mil as measured using a Hegman gauge and the method of ASTM D-1210; about 0 wt % to about 8 wt % sweetener; about 0 wt % to about 5 wt % salt, and about 0 wt % to about 3 wt % stabilizer;
b.) cooling the fluid base to about 96 degrees F. to about 105 degrees F.;
c.) blending into the cooled fluid base inclusions having a density that is about the same as a density of the ground nuts; and
d.) packaging the nut spread with inclusions to form a packaged nut spread having inclusions that are substantially evenly distributed in the packaged nut spread, the packaged nut spread having substantially the same distribution of inclusions in the proximal third, middle third, and distal third of the nut spread as packaged.

14. The method of claim 13, wherein the method produces a base having a particle size distribution with a span of about 3 to about 4, such that at least 90% of the particles are smaller than about 50 microns, at least 50% of the particles are smaller than about 15 microns, and about 10% of the particles are smaller than about 2 microns.

15. The method of claim 13, wherein the inclusions have a particle size distribution of about 1% to about 5% of inclusions retained on a 9.5 mm sieve, about 10% to about 20% of inclusions retained on an 8.7 mm sieve, about 40% to about 50% of inclusions retained on a 6.7 mm sieve, and about 15% to about 25% of inclusions retained on a 4.75 mm sieve.

16. The method of claim 13, wherein the method produces a packaged nut spread having a Brookfield viscosity from about 6,000 to about 14,000 centipoise measured at a temperature of 85 degrees C. after 60 seconds at 20 rpm with a spindle D, heliopath.

17. The method of claim 16, wherein the inclusions are added to the fluid base using a continuous flow mixer operating at a setting such that about at least 75% of the inclusions maintain the same particle size immediately after addition to the fluid base.

18. The method of claim 17, wherein the continuous flow mixer is a screw-type mixer.

19. The method of claim 17, wherein the continuous flow mixer is temperature-controlled.

20. The method of claim 17, wherein the inclusions are added to the fluid base using a continuous flow mixer operating at a speed of about 15 RPM or less.

21. The method of claim 17, wherein the inclusions are added to the fluid base using a continuous slurry mixer operating at a setting such that about at least 75% of the inclusions maintain the same particle size immediately after addition to the fluid base.
